(19) United States
(12) Patent Application Publication
(10) Pub. No.: US 2025/0250178 A1
(43) Pub. Date: Aug. 7, 2025

(54) FORSTERITE PARTICLES AND METHOD FOR PRODUCING FORSTERITE PARTICLES

(71) Applicant: DIC Corporation, Tokyo (JP)

(72) Inventors: Shaowei YANG, Qingdao, Shandong (CN); Minoru TABUCHI, Chiba (JP); Naoto YAGI, Chiba (JP); Jianjun YUAN, Chiba (JP); Xiao SUN, Qingdao, Shandong (CN); Wei Zhao, Qingdao, Shandong (CN); Jian GUO, Qingdao, Shandong (CN)

(21) Appl. No.: 18/856,233

(22) PCT Filed: Apr. 28, 2022
(86) PCT No.: PCT/CN2022/089848

§ 371 Date: Oct. 11, 2024

(51) Int. Cl. C01B 33/22

(52) U.S. Cl. CPC C01B 33/22; C01P 2002/54; C01P 2002/85; C01P 2004/03; C01P 2004/61; C01P 2004/62; C01P 2006/12

(57) ABSTRACT

It relates to forsterite particles containing molybdenum. It also relates to a method for producing the forsterite particles. The method includes firing a magnesium compound and silicon or a silicon compound in the presence of a molybdenum compound.

### TECHNICAL FIELD

The present invention relates to forsterite particles and a method for producing the forsterite particles.

### BACKGROUND ART

Forsterite is excellent in strength and is used as a thin thermal insulation material. Forsterite has high insulation resistance and is widely used as an electrical insulating material. Furthermore, forsterite is used in places, such as insulating components for vacuum tubes and base members for metal film resistors, in which adhesion to metal is regarded as important using a property that the thermal expansion coefficient thereof is high.

Forsterite has a permittivity of 6.5, is useful as a high-frequency insulation material because forsterite has low dielectric loss tangent (tan δ) and low microwave loss, and is an inorganic material expected to be used for the spread of 5G in future.

PTL 1 discloses a method for producing forsterite microparticles. In the method, a solution containing a water-soluble magnesium salt and colloidal silica at a magnesium-to-silicon molar ratio (Mg/Si) of 2 is dried by spraying the solution in an atmosphere with a temperature of 50° C. to lower than 300° C., followed by firing in an air atmosphere with a temperature of 800° C. to 1,000° C., whereby forsterite microparticles with a primary particle size in a range of 1 nm to 200 nm as observed by electron microscopy are obtained.

PTL 2 discloses silane-treated forsterite microparticles and a method for producing an organic solvent dispersion of silane-treated forsterite microparticles. The method includes (a) a step of obtaining an organic solvent dispersion by wet-crushing forsterite microparticles with a specific surface area of 5 m²/g to 100 m²/g in a dispersion medium containing an organic solvent using a bead mill and (b) a step of bonding a methyltrimethoxysilyl group, a phenyltrimethoxysilyl group, a methyltriethoxysilyl group, or a methacryloxypropyltrimethoxysilyl group to the surfaces of the forsterite microparticles by adding methyltrimethoxysilane, phenyltrimethoxysilane, methyltriethoxysilane, methacryloxypropyltrimethoxysilane, and/or a hydrolysate thereof to the organic solvent dispersion obtained in the (a) step such that the mass ratio (organosilicon compound/forsterite microparticles) of an organosilicon compound to the forsterite microparticles is from 0.01 to 0.50.

### CITATION LIST

### Patent Literature

[PTL 1]
Japanese Unexamined Patent Application Publication No. 2016-222517
[PTL 2]
Japanese Unexamined Patent Application Publication No. 2020-100561

### SUMMARY OF INVENTION

### Technical Problem

However, knowledge about conventional forsterite particles and a method for producing the same is limited and there is room for investigation.

The present invention has been made to solve such a problem as described above and it is an object of the present invention to provide forsterite particles having excellent characteristics and a method for producing the forsterite particles.

### Solution to Problem

The inventors have performed intensive investigations to solve the above problem and, as a result, have found that the use of a molybdenum compound as flux enables forsterite particles to be readily produced and also enables forsterite particles containing molybdenum to be produced.

This has led to the completion of the present invention.

That is, the present invention includes embodiments below.

(1) Forsterite particles contain molybdenum.

(2) In the forsterite particles specified in Item (1), the content of molybdenum in the forsterite particles is 0.05 mass % to 35 mass % in content (Mo₁) in terms of MoO₃ with respect to 100 mass % of the forsterite particles as determined by the XRF analysis of the forsterite particles.

(3) In the forsterite particles specified in Item (1) or (2), the content of molybdenum in a surface layer of each forsterite particle is 0.05 mass % to 25 mass % in content (Mo₂) in terms of MoO₃ with respect to 100 mass % of the surface layer of the forsterite particle as determined by the XPS surface analysis of the forsterite particle.

(4) In the forsterite particles specified in any one of Items (1) to (3), the average size of primary particles of the forsterite particles is 0.1 μm to 100 μm.

(5) In the forsterite particles specified in any one of Items (1) to (4), the specific surface area of the forsterite particles is 0.02 m²/g to 20 m²/g as measured by the BET method.

(6) A method for producing the forsterite particles specified in any one of Items (1) to (5) includes firing a magnesium compound and silicon or a silicon compound in the presence of a molybdenum compound.

(7) In the method for producing the forsterite particles specified in Item (6), the molybdenum compound is at least one selected from the group consisting of molybdenum trioxide, lithium molybdate, potassium molybdate, and sodium molybdate.

(8) In the method for producing the forsterite particles specified in Item (6) or (7), the firing temperature of the magnesium compound and silicon or the silicon compound is 800° C. to 1,600° C.

(9) In the method for producing the forsterite particles specified in any one of Items (6) to (8), the molar ratio (Mo/(Mg+Si))) of molybdenum to magnesium and silicon in the feedstock that is fired is from 0.001 to 5.

### Advantageous Effects of Invention

According to the present invention, forsterite particles having excellent characteristics and a method for producing the forsterite particles can be provided.

### BRIEF DESCRIPTION OF DRAWINGS

FIG. 1 is a SEM image of forsterite particles of Example 1.

FIG. 2 is a SEM image of forsterite particles of Example 2.

FIG. 3 is a SEM image of forsterite particles of Example 3.

FIG. 4 is a SEM image of forsterite particles of Example 4.

FIG. 5 is a SEM image of forsterite particles of Example 5.

FIG. 6 is a SEM image of forsterite particles of Example 6.

FIG. 7 is a SEM image of forsterite particles of Example 7.

FIG. 8 is a SEM image of forsterite particles of Example 8.

FIG. 9 is a SEM image of forsterite particles of Example 9.

FIG. 10 is a SEM image of forsterite particles of Comparative Example 1.

FIG. 11 is a SEM image of forsterite particles of Comparative Example 2.

FIG. 12 is a graph showing X-ray diffraction (XRD) patterns of the forsterite particles of Example 1 to 9 and Comparative Examples 1 and 2.

### DESCRIPTION OF EMBODIMENTS

Forsterite particles according to an embodiment of the present invention and a method for producing forsterite particles according to an embodiment of the present invention are described below.

### <<Forsterite Particles>>

A forsterite particle according to this embodiment is one containing molybdenum. The forsterite particles according to this embodiment contain molybdenum and have excellent characteristics, such as catalytic activity, derived from molybdenum.

The forsterite particles according to this embodiment can have an excellent characteristic, that is, a controlled shape.

The forsterite particles according to this embodiment can have an excellent characteristic that the degree of aggregation is low or no aggregation occurs.

The forsterite particles according to this embodiment can contain molybdenum derived from a molybdenum compound used in a production method described below. Using the molybdenum compound in the production method described below enables the control of the shape of forsterite particles that are produced, reduces the content of an impurity, and enables forsterite particles with a low degree of aggregation to be readily produced.

The state or amount of molybdenum contained in the forsterite particles according to this embodiment is not particularly limited. Molybdenum may be contained in the forsterite particles in the form of metallic molybdenum, a molybdenum oxide, or a partially reduced molybdenum compound. It is conceivable that molybdenum is contained in the forsterite particles in the form of MoO₃. Molybdenum may be contained in the forsterite particles in the form of MoO₂ or MoO instead of MoO₃.

The form of contained molybdenum is not particularly limited. Molybdenum may be contained in such a form that molybdenum is attached to the surfaces of the forsterite particles, in such a form that molybdenum is substituted into a portion of the crystal structure of the forsterite particles, or in an amorphous state. These may be combined.

In the present specification, controlling the shape of forsterite particles means that the shape of produced forsterite particles is not irregular. In the present specification, forsterite particles with a controlled shape mean forsterite particles of which the shape is not irregular.

The forsterite particles according to this embodiment may be those having a polyhedral shape. The forsterite particles according to this embodiment may be controlled in crystal shape and may have an automorphic polyhedral shape. Forsterite particles controlled in crystal shape can be produced by a method for producing forsterite particles according to an embodiment described below.

A cluster (powder) of forsterite particles may contain forsterite particles with a shape other than a polyhedral shape in any state. The content of forsterite particles with a polyhedral shape is preferably 80% or more, more preferably 90% or more, and further more preferably 95% or more with respect to the amount of a cluster (powder) of the forsterite particles on a mass or number basis. The form of forsterite particles can be confirmed with a scanning electron microscope (SEM).

The forsterite particles according to this embodiment are such that the size or molybdenum content of forsterite particles that are obtained can be controlled by controlling the usage amount or type of the molybdenum compound, which is a raw material, the firing temperature, or the like in the production method described below.

The average size of primary particles of the forsterite particles according to this embodiment may be 0.1-μm to 100 μm, 0.2 μm to 50 μm, or 0.3 μm to 40 μm.

The average size of primary particles of forsterite particles is calculated as a converted particle size based on a specific surface area described below on an assumption that particles are perfect spheres. A conversion equation below is used.

Primary particle size Dsa [nm]=6,000/(density [g/cm³]x specific surface area [m²/g])

The median diameter D₅₀ of the forsterite particles according to this embodiment may be 0.1 μm to 100 μm, 0.2 μm to 50 μm, or 0.3 μm to 40 μm as calculated by a laser diffraction-scattering method.

The median diameter D₅₀ of a sample of forsterite particles that is calculated by the laser diffraction-scattering method can be determined as a particle size at a cumulative volume percentage of 50% in a particle size distribution measured in a dry mode using a laser diffraction particle size distribution analyzer.

The specific surface area of the forsterite particles according to this embodiment may be 0.02 m²/g to 20 m²/g, 0.04 m²/g to 18 m²/g, or 0.05 m²/g to 15 m²/g as determined by the BET method.

The above specific surface area is calculated in such a manner that the surface area per gram of a sample that is measured from nitrogen adsorption by the BET method (Brunauer-Emmett-Teller method) using a specific surface area analyzer (for example, BELSORP-mini manufactured by MicrotracBEL Corporation) is regarded as a specific surface area (m²/g).

The forsterite particles according to this embodiment are those containing forsterite.

The forsterite particles according to this embodiment preferably contain 65 mass % or more Mg₂SiO₄, more preferably 65 mass % to 99.95 mass % Mg₂SiO₄, further more preferably 70 mass % to 99.5 mass % Mg₂SiO₄, and still further more preferably 75 mass % to 99 mass % Mg₂SiO₄ with respect to 100 mass % of the forsterite particles.

The content of magnesium contained in forsterite particles can be measured by XRF analysis. The content of magnesium in the forsterite particles according to this embodiment is preferably 30 mass % to 80 mass %, more preferably 35 mass % to 70 mass %, and further more preferably 40 mass % to 66 mass % in content (Mg₁) in terms of MgO with respect to 100 mass % of the forsterite particles as determined by the XRF analysis of the forsterite particles.

The content of silicon contained in forsterite particles can be measured by XRF analysis. The content of silicon in the forsterite particles according to this embodiment is preferably 10 mass % to 60 mass %, more preferably 15 mass % to 50 mass %, and further more preferably 20 mass % to 45 mass % in content (S₁) in terms of SiO₂ with respect to 100 mass % of the forsterite particles as determined by the XRF analysis of the forsterite particles.

The forsterite particles according to this embodiment are those containing molybdenum. The content of molybdenum contained in forsterite particles can be measured by XRF analysis. The content of molybdenum in the forsterite particles according to this embodiment is preferably 0.05 mass % or more, more preferably 0.05 mass % to 35 mass %, further more preferably 0.08 mass % to 30 mass %, and still further more preferably 0.09 mass % to 25 mass % in content (Mo₁) in terms of MoO₃ with respect to 100 mass % of the forsterite particles as determined by the XRF analysis of the forsterite particles.

In the forsterite particles according to this embodiment, the upper limit and lower limit of each of the content (Mo₁), content (S₁), and content (Mo₁) exemplified above may be freely combined. The content (Mg₁), the content (S₁), and the content (Mo₁) may also be freely combined.

The forsterite particles according to this embodiment may be, for example, forsterite particles in which the content (Mg₁) is 30 mass % to 80 mass %, the content (S₁) is 10 mass % to 60 mass %, and the content (Mo₁) is 0.05 mass % to 35 mass % with respect to 100 mass % of the forsterite particles as determined by the XRF analysis of the forsterite particles; forsterite particles in which the content (Mg₁) is 35 mass % to 70 mass %, the content (S₁) is 15 mass % to 50 mass %, and the content (Mo₁) is 0.08 mass % to 30 mass %; or forsterite particles in which the content (Mg₁) is 40 mass % to 66 mass %, the content (S₁) is 20 mass % to 45 mass %, and the content (Mo₁) is 0.09 mass % to 25 mass %.

For the above XRF analysis, an X-ray fluorescence analyzer (for example, Primus IV manufactured by Rigaku Corporation) can be used.

The content (Mg₁) in terms of MgO is a value determined from the amount of MgO that is obtained by converting the content of magnesium that is determined by the XRF analysis of forsterite particles using a calibration curve in terms of MgO.

The content (S₁) in terms of SiO₂ is a value determined from the amount of SiO₂ that is obtained by converting the content of silicon that is determined by the XRF analysis of forsterite particles using a calibration curve in terms of SiO₂.

The content (Mo₁) in terms of MoO₃ is a value determined from the amount of MoO₃ that is obtained by converting the content of molybdenum that is determined by the XRF analysis of forsterite particles using a calibration curve in terms of MoO₃.

The content of magnesium contained in a surface layer of a forsterite particle can be measured by XPS (X-ray photoelectron spectroscopy) surface analysis. The content of magnesium in a surface layer of each forsterite particle according to this embodiment is preferably 1 mass % to 70 mass %, more preferably 3 mass % to 60 mass %, and further more preferably 5 mass % to 50 mass % in content (Mg₂) in terms of MgO with respect to 100 mass % of the surface layer of the forsterite particle as determined by the XPS surface analysis of the forsterite particle.

The content of silicon contained in a surface layer of a forsterite particle can be measured by XPS (X-ray photoelectron spectroscopy) surface analysis. The content of silicon in the surface layer of each forsterite particle according to this embodiment is preferably 1 mass % to 70 mass %, more preferably 3 mass % to 60 mass %, and further more preferably 5 mass % to 50 mass % in content (S₂) in terms of SiO₂ with respect to 100 mass % of the surface layer of the forsterite particle as determined by the XPS surface analysis of the forsterite particle.

The content of molybdenum contained in a surface layer of a forsterite particle can be measured by XPS (X-ray photoelectron spectroscopy) surface analysis. The content of molybdenum in the surface layer of each forsterite particle according to this embodiment is preferably 0.05 mass % or more, more preferably 0.05 mass % to 25 mass %, further more preferably 0.08 mass % to 20 mass %, and still further more preferably 0.1 mass % to 15 mass % in content (Mo₂) in terms of MoO₃ with respect to 100 mass % of the surface layer of the forsterite particle as determined by the XPS surface analysis of the forsterite particle.

In the forsterite particles according to this embodiment, the upper limit and lower limit of each of the content (Mg₂), content (S₂), and content (Mo₂) exemplified above may be freely combined. The content (Mg₂), the content (S₂), and the content (Mo₂) may also be freely combined.

The forsterite particles according to this embodiment may be, for example, forsterite particles in which the content (Mg₂) is 1 mass % to 70 mass %, the content (S₂) is 1 mass % to 70 mass %, and the content (Mo₂) is 0.05 mass % to 25 mass % with respect to 100 mass % of the surface layer of each of the forsterite particles as determined by the XPS analysis of the forsterite particles; forsterite particles in which the content (Mg₂) is 3 mass % to 60 mass %, the content (S₂) is 3 mass % to 60 mass %, and the content (Mo₂) is 0.08 mass % to 20 mass %; or forsterite particles in which the content (Mg₂) is 5 mass % to 50 mass %, the content (S₂) is 5 mass % to 50 mass %, and the content (Mo₂) is 0.1 mass % to 15 mass %.

For the above XPS analysis, a scanning X-ray photoelectron spectrometer (for example, QUANTERA SXM manufactured by Ulvac-Phi Inc.) can be used.

The content (Mg₂) is a value that is determined as the content of MgO with respect to 100 mass % of a surface layer of a forsterite particle in such a manner that the abundance (atom %) of each element is obtained by subjecting the forsterite particle to XPS surface analysis by X-ray photoelectron spectroscopy (XPS) and the content of magnesium is converted into the content of an oxide.

The content (S₂) is a value that is determined as the content of SiO₂ with respect to 100 mass % of a surface layer of a forsterite particle in such a manner that the abundance (atom %) of each element is obtained by subjecting the forsterite particle to XPS surface analysis by X-ray photoelectron spectroscopy (XPS) and the content of silicon is converted into the content of an oxide.

The content (Mo₂) is a value that is determined as the content of MoO₃ with respect to 100 mass % of a surface layer of a forsterite particle in such a manner that the abundance (atom %) of each element is obtained by subjecting the forsterite particle to XPS surface analysis by X-ray photoelectron spectroscopy (XPS) and the content of molybdenum is converted into the content of an oxide.

In the forsterite particles according to this embodiment, the molybdenum is preferably unevenly distributed in the surface layer of each forsterite particle.

In the present specification, the term “surface layer” refers to a portion within 10 nm from the surface of each of the forsterite particles according to this embodiment.

This distance corresponds to the depth detected by XPS used for measurement in an example.

Herein, the phrase “unevenly distributed in a surface layer” refers to a state in which the mass of molybdenum or the molybdenum compound per unit volume of the surface layer is greater than the mass of molybdenum or the molybdenum compound per unit volume of a portion other than the surface layer.

In the forsterite particles according to this embodiment, a fact that molybdenum is unevenly distributed in the surface layer of each forsterite particle can be confirmed from a fact that the content (Mo₂) of molybdenum in terms of MoO₃ with respect to 100 mass % of the surface layer of the forsterite particle as determined by the XPS surface analysis of the forsterite particle is greater than the content (Mo₁) of molybdenum in terms of MoO₃ with respect to 100 mass % of the forsterite particle as determined by the XRF (X-ray fluorescence) analysis of the forsterite particle as shown in an example described below.

In the forsterite particles according to this embodiment, as an indicator of a fact that molybdenum is unevenly distributed in the surface layer of each forsterite particle, the forsterite particles according to this embodiment may be such that the surface layer uneven distribution ratio (Mo₂/Mo₁) of molybdenum that is the ratio of the content (Mo₂) in terms of MoO₃ with respect to the 100 mass % of the surface layer of each forsterite particle as determined by the XPS surface analysis of the forsterite particle to the content (Mo₁) in terms of MoO₃ with respect to the 100 mass % of the forsterite particle may be 1.1 or more or may be from 1.1 to 10.

Allowing molybdenum or the molybdenum compound to be unevenly distributed in the surface layer of each forsterite particle enables excellent characteristics such as catalytic activity to be effectively exhibited as compared to when molybdenum or the molybdenum compound is evenly present not only in the surface layer but also in a portion (inner layer) other than the surface layer.

The forsterite particles according to this embodiment can be provided in the form of a cluster of the forsterite particles. For the above magnesium content, silicon content, and molybdenum content, values determined using the cluster as a sample can be used.

The forsterite particles according to this embodiment may further contain lithium, potassium, or sodium in addition to molybdenum.

### <Method for Producing Forsterite Particles>

A method for producing forsterite particles according to an embodiment includes firing a magnesium compound and silicon or a silicon compound in the presence of a molybdenum compound. More specifically, the production method according to this embodiment is a method for producing the forsterite particles and may include mixing the magnesium compound, silicon or the silicon compound, and the molybdenum compound into a mixture and firing the mixture.

Firing the magnesium compound and silicon or the silicon compound in the presence of the molybdenum compound enables the production reaction efficiency of the forsterite particles to be increased as compared to when no molybdenum compound is used. Therefore, high-quality forsterite particles with a reduced impurity content can be efficiently produced. Furthermore, forsterite particles with a low degree of aggregation can be readily produced.

When a compound, such as magnesium silicate, containing silicon and magnesium is used is regarded as when the magnesium compound and the silicon compound are used. From a viewpoint that a production reaction of even a composite oxide such as forsterite (magnesium silicate) can be carried out well using the molybdenum compound, the magnesium compound and the silicon compound, which are raw materials, preferably include no magnesium silicate.

When a compound, such as magnesium molybdate, containing molybdenum and magnesium is used is regarded as when the molybdenum compound and the magnesium compound are used.

When a compound, such as molybdenum silicide, containing silicon and molybdenum is used is regarded as when the silicon compound and the molybdenum compound are used.

According to the method for producing the forsterite particles according to this embodiment, the forsterite particles according to the above-mentioned embodiment can be produced.

A preferred method for producing the forsterite particles includes a step (mixing step) of mixing the magnesium compound, silicon or the silicon compound, and the molybdenum compound into a mixture and a step (firing step) of firing the mixture.

### [Mixing Step]

The mixing step is a step (mixing step) of mixing the magnesium compound, silicon or the silicon compound, and the molybdenum compound into the mixture. Components of the mixture are described below.

### (Magnesium Compound)

The type of the magnesium compound is not particularly limited. Examples of the magnesium compound include magnesium hydroxide, magnesium oxide, magnesium carbonate, magnesium molybdate, magnesium silicate, magnesium acetate, magnesium chloride, magnesium nitrate, and magnesium sulfate. Magnesium hydroxide or magnesium carbonate is preferable because of the ease of reaction. Magnesium hydroxide is more preferable from a viewpoint that gas that is generated is water vapor.

The shape of the fired forsterite particles is hardly affected by the shape of the magnesium compound, which is a raw material. Therefore, the magnesium compound can be satisfactorily used in the form of, for example, spheres, irregular-shaped solids, shape with high aspect ratio (wires, fibers, ribbons, tubes, or the like), sheets, or the like.

### (Silicon or Silicon Compound)

The type of silicon or the silicon compound is not particularly limited. Not only silicon atoms but also known silicon compounds can be used. Examples of silicon and the silicon compound include artificial synthetic silicon compounds such as silica (SiO₂), magnesium silicate, molybdenum silicide, silicomolybdic acid, metallic silicon (silicon atom), organosilane compounds, silicone resins, silica microparticles, silica gel, mesoporous silica, SiC, and mullite and natural silicon compounds such as biosilica.

The shape of silicon or the silicon compound is not particularly limited. Silicon or the silicon compound can be satisfactorily used in the form of, for example, spheres, irregular-shaped solids, shape with high aspect ratio (wires, fibers, ribbons, tubes, or the like), sheets, or the like.

### (Molybdenum Compound)

Examples of the molybdenum compound include molybdenum oxide, molybdic acid, molybdenum sulfide, molybdenum silicide, silicomolybdic acid, magnesium molybdate, and a molybdate compound. Molybdenum oxide or the molybdate compound is preferable.

Examples of the molybdenum oxide include molybdenum dioxide (MoO₂) and molybdenum trioxide (MoO₃). Molybdenum trioxide is preferable.

The molybdate compound is not particularly limited and may be a salt of a molybdenum oxoanion such as MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, or Mo₈O₂₆⁴⁻. The molybdate compound may be an alkali metal salt, alkaline-earth metal salt, or ammonium salt of the molybdenum oxoanion.

The molybdate compound is preferably an alkali metal salt of the molybdenum oxoanion; more preferably lithium molybdate, potassium molybdate, or sodium molybdate; further more preferably potassium molybdate or sodium molybdate; and particularly preferably sodium molybdate.

In the method for producing the forsterite particles according to this embodiment, the molybdate compound may be a hydrate.

The molybdenum compound is preferably at least one selected from the group consisting of molybdenum trioxide, lithium molybdate, potassium molybdate, and sodium molybdate; more preferably at least one selected from the group consisting of molybdenum trioxide, potassium molybdate, and sodium molybdate; and further more preferably molybdenum trioxide and/or sodium molybdate.

In the method for producing the forsterite particles according to this embodiment, using the molybdate compound tends to reduce the proportion of the molybdenum content of the forsterite particles that are produced and is preferable from a viewpoint of increasing the crystallinity of forsterite.

The method for producing the forsterite particles according to this embodiment may include a step of firing the magnesium compound and silicon or the silicon compound in the presence of the molybdenum compound, a sodium compound, and/or a potassium compound.

The method for producing the forsterite particles according to this embodiment may include a step (mixing step) of mixing the magnesium compound, silicon or the silicon compound, the molybdenum compound, the sodium compound, and/or the potassium compound into a mixture prior to a firing step and may include a step (firing step) of firing the mixture.

In the production method according to this embodiment, using the sodium compound and/or the potassium compound allows the size of forsterite particles that are produced to be readily adjusted and enables forsterite particles with a low degree of aggregation or no aggregation to be readily produced.

Herein, a compound, such as sodium molybdate, containing molybdenum and sodium can be used instead of at least a portion of the molybdenum compound and the sodium compound. Likewise, a compound, such as potassium molybdate, containing molybdenum and potassium can be used instead of at least a portion of the molybdenum compound and the potassium compound.

Therefore, a step of mixing the magnesium compound, silicon or the silicon compound, and a compound containing molybdenum and potassium and/or sodium into a mixture is regarded as a step of mixing the magnesium compound, silicon or the silicon compound, the molybdenum compound, the potassium compound, and/or the sodium compound into a mixture.

A compound, suitable as a flux agent, containing molybdenum and sodium can be produced in the course of firing using, for example, the molybdenum compound and the sodium compound, which are less expensive and are readily available, as raw materials. Herein, both when the molybdenum compound and the sodium compound are used as flux agents and when a compound containing molybdenum and sodium is used as a flux agent are regarded as when the molybdenum compound and the sodium compound are used as flux agents, that is, when the molybdenum compound and the sodium compound are present.

A compound, suitable as a flux agent, containing molybdenum and potassium can be produced in the course of firing using, for example, the molybdenum compound and the potassium compound, which are less expensive and are readily available, as raw materials. Herein, both when the molybdenum compound and the potassium compound are used as flux agents and when a compound containing molybdenum and potassium is used as a flux agent are regarded as when the molybdenum compound and the potassium compound are used as flux agents, that is, when the molybdenum compound and the potassium compound are present.

The above-mentioned molybdenum compound may be used alone or in combination with one or more molybdenum compounds.

Sodium molybdate (Na₂MoₙO₃ₙ₊₁, where n is 1 to 3) contains sodium and therefore can function as a sodium compound described below.

Potassium molybdate (K₂MoₙO₃ₙ₊₁, where n is 1 to 3) contains potassium and therefore can function as a potassium compound described below.

### (Sodium Compound)

The sodium compound is not particularly limited. Examples of the sodium compound include sodium carbonate, sodium molybdate, sodium oxide, sodium sulfate, sodium hydroxide, sodium nitrate, sodium chloride, and metallic sodium. Among these, sodium carbonate, sodium molybdate, sodium oxide, or sodium sulfate is preferably used from a viewpoint of industrial availability and handleability.

The above-mentioned sodium compound may be used alone or in combination with one or more sodium compounds.

Similarly to the above, sodium molybdate contains molybdenum and therefore can function as the above-mentioned molybdenum compound.

### (Potassium Compound)

The potassium compound is not particularly limited. Examples of the potassium compound include potassium chloride, potassium chlorite, potassium chlorate, potassium sulfate, potassium bisulfate, potassium sulfite, potassium bisulfite, potassium nitrate, potassium carbonate, potassium bicarbonate, potassium acetate, potassium oxide, potassium bromide, potassium bromate, potassium hydroxide, potassium silicate, potassium phosphate, potassium hydrogen phosphate, potassium sulfide, potassium hydrosulfide, potassium molybdate, and potassium tungstate. In this case, the potassium compound, as well as the molybdenum compound, includes isomers. Among these, potassium carbonate, potassium bicarbonate, potassium oxide, potassium hydroxide, potassium chloride, potassium sulfate, or potassium molybdate is preferably used and potassium carbonate, potassium bicarbonate, potassium chloride, potassium sulfate, or potassium molybdate is more preferably used.

The above-mentioned potassium compound may be used alone or in combination with one or more potassium compounds.

Similarly to the above, potassium molybdate contains molybdenum and therefore can function as the above-mentioned molybdenum compound.

In the method for producing the forsterite particles according to this embodiment, the use of magnesium hydroxide, silicon dioxide, and molybdenum trioxide can be cited as a combination of preferred raw materials.

Likewise, in the method for producing the forsterite particles according to this embodiment, the use of magnesium hydroxide, silicon dioxide, and sodium molybdate or a hydrate thereof can be cited as a combination of preferred raw materials.

Likewise, in the method for producing the forsterite particles according to this embodiment, the use of magnesium hydroxide, silicon dioxide, molybdenum trioxide, and sodium molybdate or a hydrate thereof can be cited as a combination of preferred raw materials.

Firing the magnesium compound and silicon or the silicon compound in the presence of the sodium compound and the sodium compound or in the presence of the molybdenum compound and the potassium compound allows the size of forsterite particles that are produced to be readily adjusted and enables forsterite particles with a low degree of aggregation or no aggregation to be readily produced. Although reasons for this are not clear, reasons below are conceivable. For example, since K₂MoO₄ and Na₂MoO₄ are stable compounds and are unlikely to volatilize in a firing step, K₂MoO₄ and Na₂MoO₄ are unlikely to cause a severe reaction in the course of volatilization and the growth of forsterite particles is likely to be controlled. Molten K₂MoO₄ and Na₂MoO₄ exhibit a solvent-like function and it is conceivable that the size of particles can be increased by increasing, for example, the reaction time. Since molten K₂MoO₄ and Na₂MoO₄ exhibit such a solvent-like function, it is conceivable that forsterite particles are dispersed and are unlikely to aggregate.

In the method for producing the forsterite particles according to this embodiment, the molybdenum compound is used as a flux agent. In the present specification, the production method in which the molybdenum compound is used as a flux agent is simply referred to as the “flux method” in some cases. It is conceivable that after the magnesium compound, silicon or the silicon compound, and the molybdenum oxide react at high temperature due to such firing to form magnesium molybdate and silicomolybdic acid, a portion of molybdenum oxide is incorporated into forsterite particles when the magnesium molybdate is decomposed into magnesium oxide and molybdenum oxide and the silicomolybdic acid is decomposed into silicon oxide and molybdenum oxide at higher temperature. Most of molybdenum oxide evaporates and is removed outside a system. When the molybdenum compound used is sodium molybdate or potassium molybdate, molybdenum oxide is likely to react with alkali metal compounds, forms molybdates again, is hardly discharged outside the system, and remains in the system.

For a generation mechanism of the molybdenum compound contained in the forsterite particles, it is conceivable that, more specifically, Mo—O—Mg and Mo—O—Si are formed in the forsterite particles by the reaction of Mg atoms with Si atoms, most of Mo is eliminated by high-temperature firing, and a portion of molybdenum forms the Mo—O—Mg and the Mo—O—Si to remain in the forsterite particles.

Molybdenum oxide that is not incorporated into the forsterite particles can be collected by sublimation and can be reused. This enables the amount of molybdenum oxide that adheres to the surfaces of the forsterite particles to be reduced and enables inherent properties of the forsterite particles to be maximally exhibited.

On the other hand, alkali metal salts of molybdenum oxoanions do not volatilize in a firing temperature range and can be readily collected by washing after firing. Therefore, the amount of the molybdenum compound released outside a firing furnace is reduced, thereby enabling production costs to be significantly reduced.

It is conceivable that when, for example, the molybdenum compound and the sodium compound are used in combination in the flux method, the molybdenum compound and the sodium compound react to form sodium molybdate. At the same time, it is conceivable that the molybdenum compound react with the magnesium compound and the silicon compound to form magnesium molybdate and silicomolybdic acid and the magnesium molybdate and the silicomolybdic acid are decomposed by further high-temperature firing to form forsterite. It is conceivable that the evaporation of the above-mentioned flux (the sublimation of MoO₃) is suppressed and forsterite particles with a low degree of aggregation or no aggregation can be readily obtained in such a manner that magnesium molybdate and silicomolybdic acid are decomposed in the presence of, for example, sodium molybdate in a liquid phase to form forsterite, followed by growing crystals.

### (Metal Compound)

A metal compound may be used in firing as required. The method for producing the forsterite particles according to this embodiment may include a step (mixing step) of mixing the magnesium compound, silicon or the silicon compound, the molybdenum compound, the sodium compound, and/or the potassium compound with the metal compound into a mixture prior to a firing step and may include a step (firing step) of firing the mixture.

The metal compound is not particularly limited and preferably includes at least one selected from the group consisting of group 2 metal compounds and group 3 metal compounds.

Examples of the group 2 metal compounds include calcium compounds, strontium compounds, and barium compounds.

Examples of the group 3 metal compounds include scandium compounds, yttrium compounds, lanthanum compounds, and cerium compounds.

The above-mentioned metal compound means an oxide, hydroxide, oxycarbide, or chloride of a metal element. Examples of the yttrium compounds include yttrium oxide (Y₂O₃), yttrium hydroxide, and yttrium oxycarbide. Among these, the metal compound is preferably an oxide of a metal element. These metal compounds include isomers.

Among these, metal compounds of third period elements, metal compounds of fourth period elements, metal compounds of fifth period elements, and metal compounds of sixth period elements are preferable; metal compounds of the fourth period elements and metal compounds of the fifth period elements are more preferable; and metal compounds of the fifth period elements are further more preferable. In particular, a calcium compound, an yttrium compound, or a lanthanum compound is preferably used; the calcium compound or the yttrium compound is more preferably used; and the yttrium compound is particularly preferably used.

The metal compound is preferably used in a proportion of, for example, 0 mass % to 1.2 mass % (for example, 0 mol % to 1 mol %) with respect to the amount of the magnesium compound used in the mixing step.

In the method for producing the forsterite particles according to this embodiment, the blending amounts of the magnesium compound, silicon or the silicon compound, and the molybdenum compound used are not particularly limited. In a feedstock, for example, in the mixture, one to 500 parts by mass or five to 200 parts by mass of the molybdenum compound may be blended with 100 parts by mass of the sum of the blending amounts of the magnesium compound and silicon or the silicon compound.

In the method for producing the forsterite particles according to this embodiment, the molar ratio (Mg/Si) of magnesium to silicon in a feedstock, for example, in the mixture is basically 2. Since MgO that may possibly be excessively produced can be readily removed, the Mg/Si may be 2 or more, 2 to 3, or 2 to 2.5.

In the method for producing the forsterite particles according to this embodiment, the molar ratio (molybdenum/(magnesium+silicon) of molybdenum in the molybdenum compound to magnesium and silicon in the magnesium and silicon compounds in a feedstock, for example, in the mixture is preferably 0.001 or more, more preferably 0.01 or more, further more preferably 0.02 or more, and particularly preferably 0.04 or more.

The upper limit of the molar ratio of molybdenum in the molybdenum compound to magnesium and silicon in the magnesium and silicon compounds in a feedstock, for example, in the mixture may be appropriately determined. From a viewpoint of the reduction in amount of the molybdenum compound used and the increase of production efficiency, for example, the molar ratio (molybdenum/(magnesium+silicon) may be 5 or less, 3 or less, 1 or less, or 0.5 or less.

As an example of the numerical range of the molar ratio (molybdenum/(magnesium+silicon) in a feedstock, for example, in the mixture, for example, the value of molybdenum/(magnesium+silicon) may be 0.001 to 5, 0.01 to 3, 0.02 to 1, or 0.04 to 0.5.

As the usage amount of molybdenum with respect to magnesium and silicon is increased, forsterite particles with a larger size shown in the above particle size distribution tends to be obtained as shown in Table 2 in examples below.

Using various compounds in the above range allows the amount of the molybdenum compound contained in forsterite particles that are obtained to be adequate and allows forsterite particles with a controlled shape and size to be readily obtained.

### [Firing Step]

The firing step is a step of firing the mixture. The forsterite particles according to this embodiment are obtained by firing the mixture. The production method is referred to as the flux method as described above.

The flux method is classified into a solution method. More specifically, the flux method is a method for growing crystals using a fact that a crystal-flux binary phase diagram shows a eutectic. A mechanism of the flux method is inferred as described below. That is, heating a mixture of a solute and flux turns the solute and the flux into a liquid phase. Since the flux is a fusing agent, in other words, since a solute-flux binary phase diagram shows a eutectic, the solute melts at a temperature lower than the melting point thereof to form a liquid phase. Evaporating the flux in this state causes the reduction in concentration of the flux, in other words, the reduction of an effect of reducing the melting point of the solute by the flux, so that the evaporation of the flux acts as driving force to induce the crystal growth of the solute (flux evaporation method). The solute and the flux can induce the crystal growth of the solute by cooling a liquid phase (gradual cooling method).

The flux method has merits that crystals can be grown at a temperature much lower than a melting point, a crystal structure can be precisely controlled, and an automorphic crystal can be formed.

Although a mechanism of the production of forsterite particles by the flux method using the molybdenum compound as flux is not necessarily clear, for example, a mechanism below is inferred. That is, firing the magnesium compound and the silicon compound in the presence of the molybdenum compound allows magnesium molybdate and silicomolybdic acid to be formed. In this case, the magnesium molybdate and the silicomolybdic acid grow forsterite crystals at a temperature lower than the melting point of forsterite as understood from the above description. Evaporating, for example, flux decomposes the magnesium molybdate and the silicomolybdic acid and the forsterite particles can be obtained by crystal growth. That is, the molybdenum compound functions as flux and the forsterite particles are produced from intermediates that are magnesium molybdate and silicomolybdic acid.

Forsterite particles which contain molybdenum and in which the molybdenum is unevenly distributed in a surface layer of each forsterite particle can be produced by the flux method.

A firing method is not particularly limited and may be a known common method. It is conceivable that the magnesium compound, silicon or the silicon compound, and the molybdenum compound react in the course of firing to form magnesium molybdate and silicomolybdic acid. Furthermore, it is conceivable that when the firing temperature reaches 700° C. or higher, magnesium molybdate and silicomolybdic acid decompose to form forsterite particles. In the forsterite particles, it is conceivable that magnesium molybdate and silicomolybdic acid decompose into magnesia, silica, and molybdenum oxide and the molybdenum compound is then incorporated into the forsterite particles when forsterite is formed.

The state of the magnesium compound, silicon or the silicon compound, and the molybdenum compound during firing is not particularly limited. The magnesium compound, silicon or the silicon compound, and the molybdenum compound may be present in the same space in which the molybdenum compound can act on the magnesium compound and silicon or the silicon compound. In particular, a powder of the molybdenum compound, a powder of the magnesium compound, and a powder of silicon or the silicon compound may be simply mixed, may be mechanically mixed using a crusher or the like, may be mixed using a mortar or the like, or may be mixed in a dry or wet state.

Firing temperature conditions are not particularly limited and may be appropriately determined in consideration of the size of target forsterite particles, the formation of the molybdenum compound in the forsterite particles, the shape of the forsterite particles, or the like. The firing temperature may be 700° C. or higher, which is close to the decomposition temperature of magnesium molybdate and silicomolybdic acid; may be 800° C. or higher; may be 900° C. or higher; may be 950° C. or higher; or may be 1,000° C. or higher.

As the firing temperature is higher, and forsterite particles with a controlled shape and a larger size tend to be obtained. From a viewpoint of efficiently producing such forsterite particles, the firing temperature is preferably 950° C. or higher, more preferably 1,000° C. or higher, further more preferably 1,100° C. or higher, and particularly preferably 1,200° C. or higher.

In general, in order to control the shape of forsterite particles that are obtained after firing, firing needs to be performed at a high temperature of more than 1,800° C., which is close to the melting point of forsterite. This is significantly problematic for industrial use from a viewpoint of a load on a firing furnace and fuel costs.

According to an embodiment of the present invention, forsterite particles can be efficiently formed at low cost even if, for example, the maximum firing temperature at which a magnesium compound and silicon or a silicon compound are fired is 1,800° C. or lower. This contributes to the reduction of energy costs and the reduction of environmental loads.

According to the method for producing the forsterite particles according to this embodiment, automorphic forsterite particles can be formed regardless of the shape of a precursor even if the firing temperature is 1,600° C. or lower, which is much lower than the melting point of forsterite. From this viewpoint, the firing temperature is preferably 1,500° C. or lower, more preferably 1,400° C. or lower, and further more preferably 1,300° C. or lower.

The numerical range of the firing temperature at which the magnesium compound and silicon or the silicon compound in the firing step may be, for example, 800° C. to 1,600° C., 900° C. to 1,500° C., 950° C. to 1,400° C., or 1,000° C. to 1,300° C.

The heating rate may be 20° C./h to 600° C./h, 40° C./h to 500° C./h, or 80° C./h to 400° C./h from a viewpoint of production efficiency.

For the firing time, heating to a predetermined firing temperature is preferably performed in a range of 15 minutes to 10 hours. The holding time at a firing temperature may be five minutes or more, is preferably in a range of five minutes to 1,000 hours, and is more preferably in a range of one hour to 30 hours. In order to efficiently form forsterite particles, a firing temperature-holding time of two hours or more is more preferable and a firing temperature-holding time of two hours to 24 hours is particularly preferable.

Selecting conditions including, for example, a firing temperature of 800° C. to 1,600° C. and a firing temperature-holding time of two hours to 24 hours allows forsterite particles containing molybdenum according to this embodiment to be readily obtained.

A firing atmosphere is not particularly limited if an effect of the present invention is obtained; is preferably an oxygen-containing atmosphere such as air or oxygen or an inert atmosphere such as nitrogen, argon, or carbon dioxide; and is more preferably an air atmosphere when costs are taken into account.

A firing device is not necessarily limited and may be a so-called firing furnace. The firing furnace is preferably made of material that does not react with sublimated molybdenum oxide. Furthermore, a firing furnace with high airtightness is preferably used such that molybdenum oxide is efficiently used.

### [Cooling Step]

The method for producing the forsterite particles may include a cooling step. The cooling step is a step of cooling the forsterite particles crystallographically grown in the firing step.

The cooling rate is not particularly limited. The cooling rate is preferably 1° C./h to 1,000° C./h, more preferably 5° C./h to 500° C./h, and further more preferably 50° C./h to 100° C./h. The cooling rate is preferably 1° C./h or more because production time can be reduced. On the other hand, the cooling rate is preferably 1,000° C./h or less because a firing container is hardly cracked by heat shock and can be used for a long time.

A cooling method is not particularly limited and may be natural cooling. In the cooling method, a cooling device may be used.

### [Molybdenum Removal Step]

The method for producing the forsterite particles according to this embodiment may further include a molybdenum removal step of removing at least a portion of molybdenum after the firing step as required.

Examples of a method for removing molybdenum include washing and a high-temperature treatment. These may be performed in combination.

Since molybdenum sublimates during firing as described above, controlling the firing time, the firing temperature, or the like enables the content of molybdenum present in the surface layer of each forsterite particle to be controlled and enables the content or state of molybdenum present in a portion (inner layer) other than the surface layer of the forsterite particle to be controlled.

Molybdenum can adhere to the surfaces of the forsterite particles. The molybdenum can be removed by washing with water, an aqueous ammonia solution, an aqueous sodium hydroxide solution, or the like instead of the sublimation.

In this operation, the content of molybdenum in the forsterite particles can be controlled by appropriately changing the amount of water used, the concentration or usage amount of the aqueous ammonia solution or the aqueous sodium hydroxide solution, a washed portion, the washing time, and the like.

An example of a high-temperature treatment method is a method in which the mixture forsterite particles and molybdenum compounds are heated to a temperature higher than or equal to the sublimation point or boiling point of the molybdenum compound.

### [Crushing Step]

A fired product obtained through the firing step does not satisfy the range of a particle size preferable for applications that are considered in some cases because the forsterite particles aggregate. Therefore, the forsterite particles may be crushed as required so as to satisfy the range of a preferable particle size.

A method for crushing the fired product is not particularly limited. Conventionally known crushers such as ball mills, jaw crushers, jet mills, disc mills, Spectro mills, grinders, and mixer mills can be used.

### [Classification Step]

The fired product, obtained through the firing step, containing the forsterite particles may be appropriately subjected to a classification treatment for the purpose of adjusting the range of a particle size. The term “classification treatment” refers to an operation of grouping particles depending on the size of the particles.

Classification may be performed in either a wet or dry mode. From a viewpoint of productivity, dry classification is preferable. Examples of dry classification include classification by sieving and pneumatic classification which is performed by a difference between centrifugal force and fluid drag. Pneumatic classification is preferable from a viewpoint of classification precision and can be performed using a classifier, such as an air classifier in which the Coanda effect is used, a spiral air classifier, a forced vortex centrifugal classifier, or a quasi-free vortex centrifugal classifier.

The above-mentioned crushing step or classification step can be performed in a necessary stage. For example, the average size of the forsterite particles that are obtained can be adjusted by whether crushing and classification are performed or by selecting conditions thereof.

Forsterite particles according to an embodiment or forsterite particles obtained by a production method according to an embodiment have a low degree of aggregation or are not aggregated. Therefore, the forsterite particles are likely to exhibit inherent properties, are more excellent in handleability, and are preferable from a viewpoint that the forsterite particles are more excellent in dispersibility when the forsterite particles are dispersed in a dispersion medium and are used.

In accordance with the method for producing the forsterite particles according to the above embodiment, forsterite particles with a low degree of aggregation or no aggregation can be readily produced. Therefore, the method has an excellent advantage that forsterite particles having excellent target properties can be produced with high productivity even if the crushing step or the classification step is not performed.

In accordance with the method for producing the forsterite particles according to the above-mentioned embodiment, high-quality forsterite particles which contain molybdenum and which have a controlled shape can be produced with high efficiency.

### EXAMPLES

The present invention further described below in detail with reference to examples. The present invention is not limited to the examples below.

### Production of Forsterite Particles

### Example 1

Into a 100 ml polypropylene bottle, 5.8 g of magnesium hydroxide (Kisuma® 5, produced by Kyowa Chemical Industry Co., Ltd.), 3.0 g of silicon dioxide (VN3, produced by Tosoh Silica Corporation), 8.8 g of sodium molybdate dihydrate (a reagent produced by Kanto Chemical Co., Inc.), 30 g of ion-exchanged water, and 120 g of 5 mmφ zirconia beads were charged, followed by mixing and crushing for 120 minutes using a paint shaker, whereby a mixture was obtained. The obtained mixture was transferred to a metal vat and was dried in a 120° C. oven, followed by crushing dry matter with a mixer (manufactured by Osaka Chemical Co., Ltd.). Crushed raw materials were put into a crucible and were fired at 1,500° C. for 10 hours in a ceramic electric furnace. Heating was performed at 2° C./min. After cooling, the crucible was taken out and a white powder was obtained.

Subsequently, the obtained white powder was transferred to a beaker and 200 g of ion-exchanged water was added to the beaker, followed by stirring for three hours, whereby sodium molybdate was dissolved in the ion-exchanged water. Next, filtering was performed by suction filtration using 5 C filter paper and obtained particles were dried at 120° C., whereby 6.8 g of a white powder of Example 1 was obtained.

### Example 2

Into an 80 ml zirconia pot, 5.8 g of magnesium hydroxide (Kisuma® 5, produced by Kyowa Chemical Industry Co., Ltd.), 3.0 g of silicon dioxide (VN3, produced by Tosoh Silica Corporation), 0.88 g of molybdenum trioxide (produced by Nippon Inorganic Colour & Chemical Co., Ltd.), and 100 g of 5 mmφ zirconia beads were charged, followed by mixing and crushing at 200 rpm for 60 minutes using a planetary mill (P-5, manufactured by Fritsch GmbH), whereby a mixture was obtained. The obtained mixture was put into a crucible and was fired at 1,300° C. for 10 hours in a ceramic electric furnace. Heating was performed at 2° C./min. After cooling, the crucible was taken out and a white powder was obtained.

Subsequently, the obtained white powder was transferred to a beaker and 200 g of 0.5% ammonia water was added to the beaker, followed by stirring for three hours, whereby remaining molybdenum trioxide was dissolved in the ammonia water. Next, filtering was performed by suction filtration using 5 C filter paper and obtained particles were dried at 120° C., whereby 6.8 g of a white powder of Example 2 was obtained.

### Example 3

A white powder of Example 3 was obtained in the same manner as that used in Example 1 except that the firing temperature was 1,000° C. and the heating rate was 5° C./min.

### Example 4

A white powder of Example 4 was obtained in the same manner as that used in Example 1 except that the firing temperature was 1,300° C. and the heating rate was 5° C./min.

### Example 5

A white powder of Example 5 was obtained in the same manner as that used in Example 2 except that the firing temperature was 1,100° C. and the heating rate was 5° C./min.

### Example 6

Into a 100 ml polypropylene bottle, 8.28 g of magnesium hydroxide (Kisuma® 5, produced by Kyowa Chemical Industry Co., Ltd.), 4.29 g of silicon dioxide (VN3, produced by Tosoh Silica Corporation), 6.96 g of sodium molybdate dihydrate (a reagent produced by Kanto Chemical Co., Inc.), 4.11 g of molybdenum trioxide (produced by Nippon Inorganic Colour & Chemical Co., Ltd.), 30 g of ion-exchanged water, and 120 g of 5 mmφ zirconia beads were charged, followed by mixing and crushing for 120 minutes using a paint shaker, whereby a mixture was obtained. The obtained mixture was transferred to a metal vat and was dried in a 120° C. oven, followed by crushing dry matter with a mixer (manufactured by Osaka Chemical Co., Ltd.). Crushed raw materials were put into a crucible and were fired at 900° C. for 10 hours in a ceramic electric furnace. Heating was performed at 5° C./min. After cooling, the crucible was taken out and a white powder was obtained.

Subsequently, the obtained white powder was transferred to a beaker and 200 g of ion-exchanged water was added to the beaker, followed by stirring for three hours, whereby sodium molybdate was dissolved in the ion-exchanged water. Next, filtering was performed by suction filtration using 5 C filter paper and obtained particles were dried at 120° C., whereby 10.2 g of a white powder of Example 6 was obtained.

### Example 7

A white powder of Example 7 was obtained in the same manner as that used in Example 6 except that the firing temperature was 1,100° C.

### Example 8

A white powder of Example 8 was obtained in the same manner as that used in Example 6 except that the firing temperature was 1,300° C.

### Example 9

A white powder of Example 9 was obtained in the same manner as that used in Example 6 except that the firing temperature was 1,500° C. and the heating rate was 2° C./min.

### Examples 10 to 13

White powders of Examples 10 to 13 were obtained in the same manner as that used in Example 4 except that the usage amount of sodium molybdate dihydrate was changed to mass shown in Table 2.

### Comparative Example 1

Into an 80 ml zirconia pot, 5.8 g of magnesium hydroxide (Kisuma® 5, produced by Kyowa Chemical Industry Co., Ltd.), 3.0 g of silicon dioxide (VN3, produced by Tosoh Silica Corporation), and 100 g of 5 mmφ zirconia beads were charged, followed by mixing and crushing for 60 minutes using a planetary mill (P-5, manufactured by Fritsch GmbH), whereby a mixture was obtained. The obtained mixture was put into a crucible and was fired at 1,100° C. for 10 hours in a ceramic electric furnace. Heating was performed at 5° C./min. After cooling, the crucible was taken out and a white powder of Comparative Example 1 was obtained.

### Comparative Example 2

A white powder of Comparative Example 2 was obtained in the same manner as that used in Comparative Example 1 except that the firing temperature was 1,300° C.

### <Evaluation>

A sample powder was taken from the powder obtained in each of the examples and the comparative examples and was evaluated as described below.

### [Crystal Structure Analysis: X-Ray Diffraction (XRD) Method]

The sample powder was filled into a 0.5 mm deep holder for measurement samples, the holder was set to a wide-angle X-ray diffraction (XRD) instrument (Ultima IV, manufactured by Rigaku Corporation), and the sample powder was measured under conditions including Cu Kα radiation, 40 kV/40 mA, a scanning speed of 2°/min, and a scanning range of 10° to 70°.

### [Measurement of Specific Surface Area of Forsterite Particles]

The specific surface area of forsterite particles was measured using a specific surface area analyzer (BELSORP-mini, manufactured by MicrotracBEL Corporation). The surface area per gram of a sample that was measured from nitrogen adsorption by the BET method was calculated as a specific surface area (m²/g).

### [Primary Particle Size]

The primary particle size of the forsterite particles was calculated as a converted particle size based on the above specific surface area on an assumption that particles were perfect spheres. A conversion equation below was used. Primary particle size Dsa [nm]=6,000/(density [g/cm³]X specific surface area [m²/g])

In the examples, the density of the forsterite particles was calculated to be 3.0 g/cm³.

### [Measurement of Size Distribution]

The particle size distribution of the sample powder was measured in a dry mode under conditions including a dispersive pressure of 3 bar and a suction pressure of 90 mbar using a laser diffraction particle size distribution analyzer (HELOS (H3355) & RODOS, manufactured by Japan Laser Corporation). The particle size at a point where a cumulative volume distribution curve intersects with a horizontal axis at 50% was determined to be D₅₀.

### [X-Ray Fluorescence (XRF) Analysis]

About 70 mg of the sample powder was taken on filter paper, was covered with a PP film, and was subjected to X-ray fluorescence (XRF) analysis under conditions below using an X-ray fluorescence analyzer, Primus IV (manufactured by Rigaku Corporation).

Measurement conditions
EZ scan mode
Measurement elements: F to U
Measurement time: standard
Measurement diameter: 10 mm
Residue (balance component): not present

The magnesium content, silicon content, and molybdenum content of the forsterite particles that were determined by XRF analysis were converted into oxide contents, whereby results of a MgO content (Mg₁) with respect to 100 mass % of the forsterite particles, a SiO₂ content (S₁) with respect to 100 mass % of the forsterite particles, and a MoO₃ content (Mo₁) with respect to 100 mass % of the forsterite particles were obtained.

### [XPS Surface Analysis]

The surface element analysis of the sample powder was carried out by X-ray photoelectron spectroscopy (XPS) using Quantera SXM manufactured by Ulvac-Phi Inc. and monochromatized Al Kα radiation as an X-ray source. In the measurement of a 1,000 μm square area, the average of n=3 measurements was obtained in atom % for each element.

The magnesium and silicon contents of a surface layer of each forsterite particle that were determined by XPS analysis and the molybdenum content of the surface layer were converted into oxide contents, whereby a MgO content (Mg₂) (mass %) with respect to 100 mass % of the surface layer of the forsterite particle, a SiO₂ content (S₂) (mass %) with respect to 100 mass % of the surface layer of the forsterite particle, and a MoO₃ content (Mo₂) (mass %) with respect to 100 mass % of the surface layer of the forsterite particle were determined.

### <Results>

Values obtained by the above evaluation are shown in Tables 1 to 2. Incidentally, “N. D.” is an abbreviation for “not detected” and represents non-detection.

TABLE 1

| | | | | Example | Example | Example | Example | Example | Example |
|---|---|---|---|---|---|---|---|---|---|
| | | | | 1 | 2 | 3 | 4 | 5 | 6 |
| Producing | Mg(OH)₂ | | g | 5.80 | 5.80 | 5.80 | 5.80 | 5.80 | 8.28 |
| condition | SiO₂ | | g | 3.00 | 3.00 | 3.00 | 3.00 | 3.00 | 4.29 |
| | Na₂MoO₄•2H₂O | | g | 8.80 | — | 8.80 | 8.80 | — | 6.96 |
| | MoO₃ | | g | — | 0.88 | — | — | 0.88 | 4.11 |
| | (magnesium compound + | | mass | 1/1 | 10/1 | 1/1 | 1/1 | 10/1 | 1/1 |
| | silicon compound)/ | | ratio | | | | | | |
| | molybdenum compound | | | | | | | | |
| | Mg/Si | | molar | 2 | 2 | 2 | 2 | 2 | 2 |
| | | | ratio | | | | | | |
| | Mo/(Mg + Si) | | molar | 0.24 | 0.04 | 0.24 | 0.24 | 0.04 | 0.27 |
| | | | ratio | | | | | | |
| | firing temperature | | ° C. | 1500 | 1300 | 1000 | 1300 | 1100 | 900 |
| | firing time | | h | 10 | 10 | 10 | 10 | 10 | 10 |
| Evaluation | detection of an impurity | | | − | − | − | − | − | − |
| | degree of aggregation | | | − | − | − | − | − | − |
| | specific Surface Area | | m²/g | 0.08 | 0.9 | 12.46 | 0.55 | 0.75 | 1.51 |
| | primary particle | | μm | 25.0 | 2.2 | 0.16 | 3.6 | 2.7 | 1.3 |
| | size (Dₛₐ) | | | | | | | | |
| | D50 | | μm | 26.2 | 9.1 | 1.6 | 6.6 | 1.8 | 2.0 |
| | XRF | MoO₃ (Mo₁) | mass % | 0.1 | 19.6 | 2.1 | 0.8 | 15.0 | 2.7 |
| | | MgO (Mg₁) | mass % | 58.9 | 51.7 | 60.0 | 62.1 | 53.8 | 57.2 |
| | | SiO₂ (S₁) | mass % | 40.5 | 28.1 | 36.9 | 36.3 | 30.5 | 39.5 |
| | XPS | MoO₃ (Mo₂) | mass % | 0.4 | 7.5 | 0.5 | 0.9 | 6.8 | 1.4 |
| | | MgO (Mg₂) | mass % | 12.4 | 34.6 | 40.6 | 24.6 | 32.9 | 23.7 |
| | | SiO₂ (S₂) | mass % | 46.4 | 7.9 | 23.9 | 27.6 | 13.1 | 37.3 |

| | | | | | | |
|---|---|---|---|---|---|---|
| the surface layer uneven | 4.0 | 0.4 | 0.2 | 1.1 | 0.5 | 0.5 |
| distribution ratio of the | | | | | | |
| MoO₃ (Mo₂/Mo₁) | | | | | | |

| | | | Example | Example | Example | Comparative | Comparative |
|---|---|---|---|---|---|---|---|
| | | | 7 | 8 | 9 | Example 1 | Example 2 |
| Producing | Mg(OH)₂ | g | 8.28 | 8.28 | 8.28 | 5.80 | 5.80 |
| condition | SiO₂ | g | 4.29 | 4.29 | 4.29 | 3.00 | 3.00 |
| | Na₂MoO₄•2H₂O | g | 6.96 | 6.96 | 6.96 | — | — |
| | MoO₃ | g | 4.11 | 4.11 | 4.11 | — | — |
| | (magnesium compound + | mass | 1/1 | 1/1 | 1/1 | 1/1 | 1/1 |
| | silicon compound)/ | ratio | | | | | |
| | molybdenum compound | | | | | | |
| | Mg/Si | molar | 2 | 2 | 2 | 2 | 2 |
| | | ratio | | | | | |
| | Mo/(Mg + Si) | molar | 0.27 | 0.27 | 0.27 | — | — |
| | | ratio | | | | | |
| | firing temperature | ° C. | 1100 | 1300 | 1500 | 1100 | 1300 |
| | firing time | h | 10 | 10 | 10 | 10 | 10 |
| Evaluation | detection of an impurity | | − | − | − | + | + |
| | degree of aggregation | | − | − | − | + | + |
| | specific Surface Area | m²/g | 3.15 | 0.17 | 0.13 | 9.43 | 2.60 |
| | primary particle size | μm | 0.63 | 12.0 | 15.0 | 0.21 | 0.77 |
| | (Dₛₐ) | | | | | | |
| | D50 | μm | 2.0 | 9.3 | 25.8 | 4.8 | 5.9 |

| | | | | | | | |
|---|---|---|---|---|---|---|---|
| XRF | MoO₃ (Mo₁) | mass % | 1.8 | 1.7 | 5.0 | N.D. | N.D. |
| | MgO (Mg₁) | mass % | 57.7 | 56.6 | 45.8 | 58.8 | 58.4 |
| | SiO₂ (S₁) | mass % | 40.0 | 40.8 | 42.3 | 40.7 | 40.9 |
| XPS | MoO₃ (Mo₂) | mass % | 1.2 | 2.2 | 4.5 | N.D. | N.D. |
| | MgO (Mg₂) | mass % | 21.1 | 11.9 | 8.8 | 31.3 | 30.9 |
| | SiO₂ (S₂) | mass % | 36.8 | 38.6 | 38.9 | 12.7 | 8.8 |

| | | | | | |
|---|---|---|---|---|---|
| the surface layer uneven | 0.7 | 1.3 | 0.9 | — | — |
| distribution ratio of the | | | | | |
| MoO₃ (Mo₂/Mo₁) | | | | | |

TABLE 2

| | | | Example | Example | Example | Example | Example |
|---|---|---|---|---|---|---|---|
| | | | 10 | 11 | 12 | 13 | 4 |
| Producing | Mg(OH)₂ | g | 5.80 | 5.80 | 5.80 | 5.80 | 5.80 |
| condition | SiO₂ | g | 3.00 | 3.00 | 3.00 | 3.00 | 3.00 |
| | Na₂MoO₄•2H₂O | g | 0.88 | 2.64 | 4.40 | 6.16 | 8.80 |
| | MoO₃ | g | — | — | — | — | — |
| | (magnesium compound + | mass | 10/1 | 10/3 | 10/5 | 10/7 | 10/10 |
| | silicon compound)/ | ratio | | | | | |
| | molybdenum compound | | | | | | |
| | Mg/Si | molar | 2 | 2 | 2 | 2 | 2 |
| | | ratio | | | | | |
| | Mo/(Mg + Si) | molar | 0.024 | 0.072 | 0.12 | 0.17 | 0.24 |
| | | ratio | | | | | |
| | firing temperature | ° C. | 1300 | 1300 | 1300 | 1300 | 1300 |
| | firing time | h | 10 | 10 | 10 | 10 | 10 |
| Evaluation | detection of an impurity | | — | — | — | — | — |
| | degree of aggregation | | — | — | — | — | — |
| | D50 | μm | 2.3 | 3.8 | 5.2 | 5.8 | 6.6 |

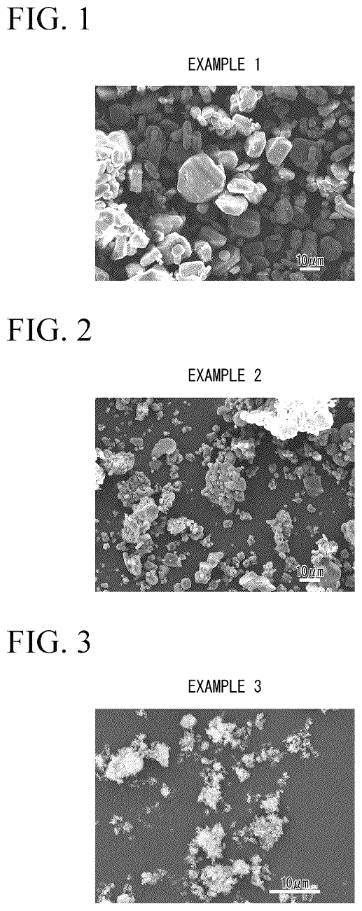

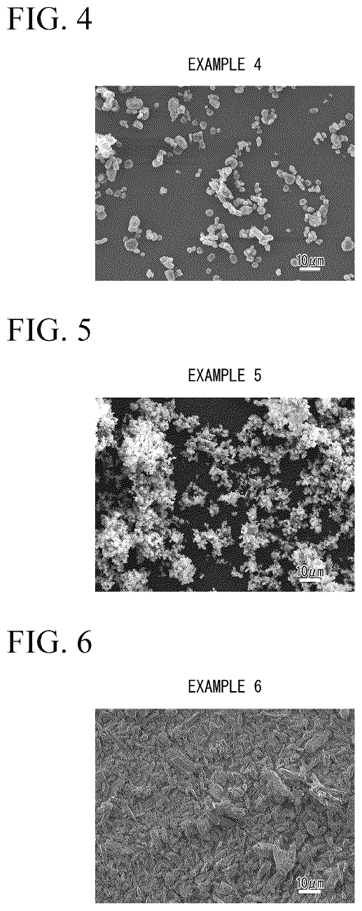

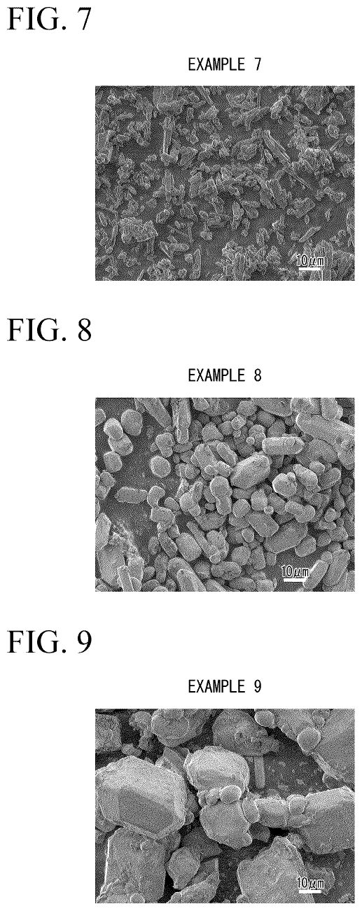

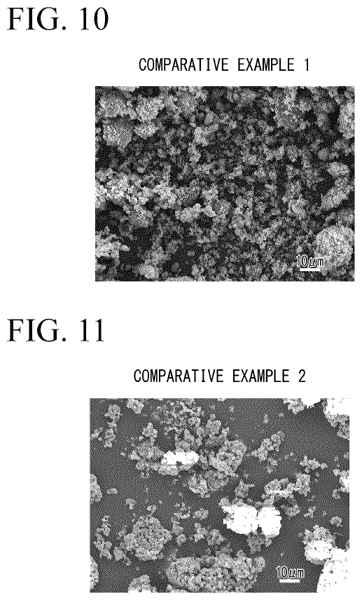

SEM images of the powders of the examples and the comparative examples that were photographed with a scanning electron microscope (SEM) are shown in FIGS. 1 to 11. In the powder of each of Examples 1 to 9, a large number of beautiful polyhedral particles were observed, which showed that the crystal shape of particles was controlled in the course of production. On the other hand, in the powder of each of Comparative Examples 1 and 2, irregular-shaped particles that had no specific shape were observed.

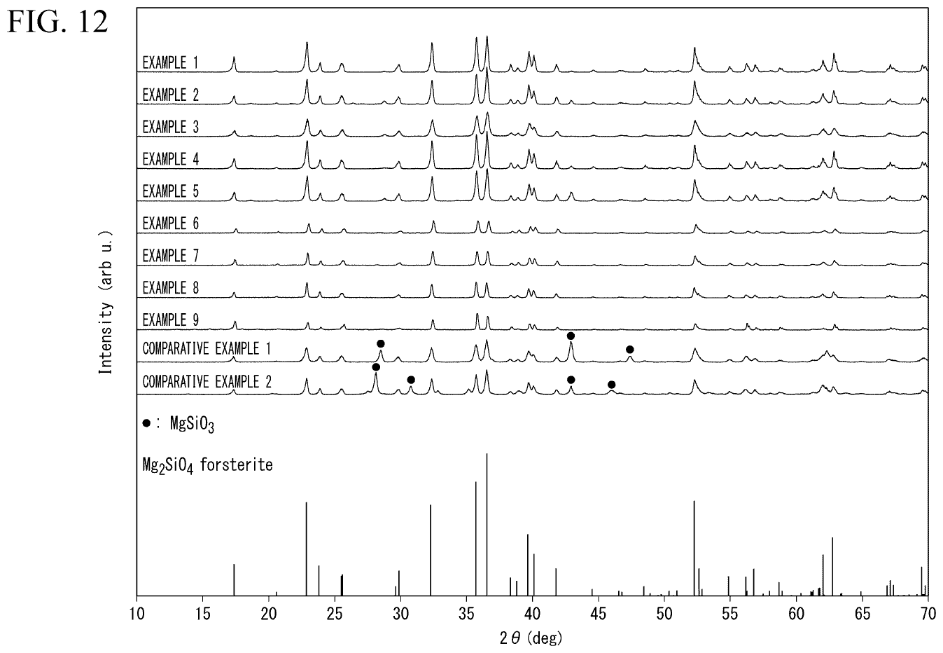

Results of XRD analysis are shown in FIG. 12. Peaks (unmarked peaks) originating from forsterite (Mg₂SiO₄) were found in samples of the examples and the comparative examples.

From results of the above SEM observation and XRD analysis, it was confirmed that the powder obtained in each of the examples and the comparative examples was made of forsterite particles containing forsterite.

In the sample powders of Examples 1 to 9, few peaks originating from impurities were observed (FIG. 12, “-” in the detection of an impurity in Table 1). On the other hand, in the sample powders of Comparative Examples 1 and 2, peaks (peaks marked with ● in FIG. 12) originating from impurities such as enstatite (MgSiO₃) were clearly detected (“+” in the detection of an impurity in Table 1). This suggested that, in the sample powders of Comparative Examples 1 and 2, a production reaction of forsterite was not completed and unreacted reactants remained.

This showed that, in each example in which a magnesium compound and a silicon compound were fired in the presence of a molybdenum compound, the production reaction of forsterite proceeded well even at a relatively low firing temperature, 900° C. to 1,500° C., and high-quality forsterite particles in which the contents of the impurities were reduced and which had a controlled shape could be produced with high efficiency.

After forsterite particles were dispersed in ethanol, the forsterite particles were observed with a TEM and the degree of aggregation of the forsterite particles was evaluated in accordance with criteria below.

+: The aggregation of particles is found.

−: The distinct aggregation of particles is not found.

Although the distinct aggregation or fusion of forsterite particles of Comparative Examples 1 and 2 was found (the degree of aggregation was +), the distinct aggregation of forsterite particles of Examples 1 to 9 was not found (the degree of aggregation was −).

This showed that, in each example in which a magnesium compound and a silicon compound were fired in the presence of a molybdenum compound, the progress of reaction during firing was good and forsterite particles with a low degree of aggregation or no aggregation could be readily produced.

In comparison between Examples 2 and 4 at the same firing temperature, the degree of aggregation of the forsterite particles obtained in Example 4, in which a raw material used was Na₂MOO₄·2H₂O, was kept lower than that of the forsterite particles obtained in Example 2.

This shows that firing a magnesium compound and a silicon compound in the presence of a molybdenum compound allows forsterite particles with a low degree of aggregation to be readily obtained.

In examples (refer to, for example, Examples 1, 3, and 4), as the firing temperature was higher, forsterite particles with a larger size tended to be obtained.

As described above, controlling the firing temperature enables the size of forsterite particles to be controlled and enables forsterite particles with a desired size to be produced.

Values of the above MgO content (Mg₁), SiO₂ content (S₁), MoO₃ content (Mo₁), MgO content (Mg₂), SiO₂ content (S₂), and MoO₃ content (Mo₂) are shown in Table 1.

From results of the MoO₃ content (Mo₁), it was confirmed that forsterite particles containing molybdenum were obtained.

From results of the MoO₃ content (Mo₂), the forsterite particles of Examples 1 to 9 have a surface layer containing molybdenum and various actions, such as catalytic activity, due to molybdenum can be expected to be exhibited.

Calculation results of the surface layer uneven distribution ratio (Mo₂/Mo₁) of the MoO₃ content (Mo₂) to the MoO₃ content (Mo₁) are shown in Table 1.

As is clear from results of the surface layer uneven distribution ratio (Mo₂/Mo₁), in the forsterite particles of Examples 1, 4, and 8, the molybdenum content of the surface layer of each forsterite particle as determined by XPS surface analysis is greater than the molybdenum content determined by XRF analysis. From this, it is confirmed that molybdenum is unevenly distributed in the surface layer of the forsterite particle and it can be expected that various actions due to molybdenum are effectively exhibited.

The forsterite particles obtained in Examples 2 and 5, in which a raw material used was MoO₃, had a higher MoO₃ content (Mo₁) as compared to those obtained in other examples, though the (magnesium compound+silicon compound)/molybdenum compound ratio of raw materials was 10/1. In Examples 6 to 9, in which a raw material used was MoO₃, the MoO₃ content (Mo₁) tended to be high.

As described above, controlling the amount or type of a molybdenum compound used enabled the amount of molybdenum contained in forsterite particles to be controlled and enabled forsterite particles containing a desired amount of molybdenum to be produced.

Referring to Table 2, as the molar ratio (Mo/(Mg+Si)) of molybdenum to magnesium and silicon in raw materials was higher, forsterite particles with a larger size tended to be obtained.

As described above, controlling the amount of a molybdenum compound used enabled the size of forsterite particles to be controlled and enabled forsterite particles having a desired size to be produced.

Components in embodiments and combinations thereof are examples. Components may be added, omitted, substituted, and modified without departing from the sprit of the present invention. The present invention is not limited by embodiments but is limited only by the scope of the appended claims.

1. Forsterite particles containing molybdenum.

2. The forsterite particles according to claim 1, wherein the content of molybdenum in the forsterite particles is 0.05 mass % to 35 mass % in content (Mo₁) in terms of MoO₃ with respect to 100 mass % of the forsterite particles as determined by the XRF analysis of the forsterite particles.

3. The forsterite particles according to claim 1, wherein the content of molybdenum in a surface layer of each forsterite particle is 0.05 mass % to 25 mass % in content (Mo₂) in terms of MoO₃ with respect to 100 mass % of the surface layer of the forsterite particle as determined by the XPS surface analysis of the forsterite particle.

4. The forsterite particles according to claim 1, wherein the average size of primary particles of the forsterite particles is 0.1 μm to 100 μm.

5. The forsterite particles according to claim 1, wherein the specific surface area of the forsterite particles is 0.02 m²/g to 20 m²/g as measured by the BET method.

6. A method for producing the forsterite particles according to claim 1, comprising firing a magnesium compound and silicon or a silicon compound in the presence of a molybdenum compound.

7. The method for producing the forsterite particles according to claim 6, wherein the molybdenum compound is at least one selected from the group consisting of molybdenum trioxide, lithium molybdate, potassium molybdate, and sodium molybdate.

8. The method for producing the forsterite particles according to claim 6, wherein the firing temperature of the magnesium compound and silicon or the silicon compound is 800° C. to 1,600° C.

9. The method for producing the forsterite particles according to claim 6, wherein the molar ratio (Mo/(Mg+Si))) of molybdenum to magnesium and silicon in the feedstock that is fired is from 0.001 to 5.
